(19) United States
(12) Patent Application Publication
(10) Pub. No.: US 2007/0221135 A1
(43) Pub. Date: Sep. 27, 2007

(54) PROTECTIVE COVER

(76) Inventor: Owen Slater, Lemont, IL (US)

Correspondence Address: SACHNOFF & WEAVER, LTD., 10 SOUTH WACKER DRIVE, CHICAGO, IL, 60606-7507, US

(21) Appl. No.: 11/560,939

(22) Filed: Nov. 17, 2006

Related U.S. Application Data
(60) Provisional application No. 60/737,969, filed on Nov. 17, 2005.

(51) Int. Cl. A01K 1/03

(52) U.S. Cl. 119/474; 119/498

(57) ABSTRACT

A cargo protector disclosed herein provides a flexible panel having at least one channel located on the flexible panel to hold a tensile strip, wherein the tensile strip is adapted to be folded into at least three loops in such a manner. The arrangement of the tensile strip inside the flexible panel as disclosed herein allows the cargo protector to be conveniently packed away into a compact storage form or to be quickly and easily deployed for a number of different uses.

### CROSS REFERENCE TO RELATED APPLICATIONS

This application claims priority of the provisional application No. 60/737,969 filed on Nov. 17, 2005 in the name of Owen Slater and entitled “”Protective Cover,” which is incorporated herein by reference in its entirety.

### FIELD

This patent generally relates to the field of automobile accessories and specifically to automobile accessories for carrying pets or other materials.

### BACKGROUND

Due to increased mobility of people in modern societies and extended use of automobiles, there is increasing need to move personal belongings, pets, etc., in automobiles. However, it is often difficult to organize personal belongings, in an ordered manner in a car, or other automobile. People often use cumbersome containers, baskets, carts, etc., to transport personal belongings, such as groceries, beach entertainment equipment, school supplies, etc., in their cars. Similarly, when transporting dogs, cats, or other similar pet animals, people use animal cages, and other cumbersome means. Often people just let their pets on their seats or dump their belongings in their car, mainly due to cumbersome nature of alternatives. This may result in damage to the interior of the car and/or the upholstery.

Devices used to transport pet animals in vehicles have generally been of the container type for small dogs, which strap or hook on the seats of the automobiles providing a comfortable ride for the pet animal. There are a number of such devices disclosed in various prior art patents. However, none of these devices, seat cushions, etc., provide for a less cumbersome solution. Especially there is a need to have a device that can be used to transport personal belongings, pets, etc., in vehicles without sacrificing convenience of doing so. Moreover, there is also need to provide a device that can be used to transport personal belongings, pets, etc., and that can be easily folded into a compact structure for storage. Also, there is a need to provide a device that can be used to transport personal belongings, pets, etc., and that can be easily cleaned, washed, using standard washer/dryer, or other conventional means.

### BRIEF DESCRIPTION OF DRAWINGS

While the appended claims set forth the features of the present patent with particularity, the patent, together with its objects and advantages, may be best understood from the following detailed description taken in conjunction with the accompanying drawings, of which:

FIG. 1 illustrates an embodiment of a protective cover;

FIG. 2 illustrates an alternate view of the protective cover of FIG. 1;

FIG. 3 illustrated a top view of protective cover of FIG. 1 when it is folded;

FIG. 4 illustrates a bottom view of the protective cover of FIG. 1 when it is folded;

FIGS. 4a-b illustrate alternate bottom views of the protective cover of FIG. 1 showing methods of inserting and removing tensile strip;

FIG. 5 is a design drawing of the protective cover of FIG. 1;

FIG. 6 is a top perspective view of the protective cover, shown on a rear seat of a vehicle in an open condition;

FIG. 7 is an enlarged perspective view of a connecting loop of the cover shown in FIG. 5;

FIG. 8 is an enlarged perspective view of a pair of seat belt openings in the cover shown in FIG. 5;

FIG. 9 is a perspective view of a tensile strip that may be used with the protective cover;

FIGS. 10-12 are perspective views of a tensile strip shown in FIG. 8, shown in various deformed conditions;

FIGS. 13 illustrates a plurality of views showing steps involved in transforming the protective cover from the open condition, FIG. 13a, to the storage condition, FIG. 13f;

FIG. 14 is a perspective view of the cover within the storage case;

FIG. 15 is a perspective view of the storage case shown with an accessory strap; and

FIG. 16 illustrates a method of unfolding the protective cover for use in a car.

### DETAILED DESCRIPTION

A cargo protector disclosed herein provides a flexible panel having at least one channel located on the flexible panel to hold a tensile strip, wherein the tensile strip is adapted to be folded into at least three loops in such a manner. The arrangement of the tensile strip inside the flexible panel as disclosed herein allows the cargo protector to be conveniently packed away into a compact storage form or to be quickly and easily deployed for a number of different uses.

An embodiment of the protective cover includes a flexible panel of an approximately rectangular shape, the panel having a right edge and a left edge opposite and parallel to each other, and a top edge and a bottom edge opposite and parallel to each other, at least one channel located on the flexible panel to hold a tensile strip, wherein the tensile strip is adapted to be folded into at least three loops connected to each other, wherein each of at least two but no more than three sections of the tensile strip are adjacent to one of the right edge, the left edge, the top edge and the bottom edge of the flexible panel.

According to an alternate embodiment of the protective cover each of three sections of the tensile strip are adjacent to one of the right edge, the left edge, the top edge and the bottom edge of the flexible panel. According to yet another embodiment of the protective cover, the tensile strip is made of at least one of: (1) a metallic spring; and (2) a spring made of plastic material. According to yet another embodiment, the protective cover further comprises a zipper located on the flexible panel the zipper being adjacent to a section of the tensile strip that is not adjacent to any edge of the flexible panel.

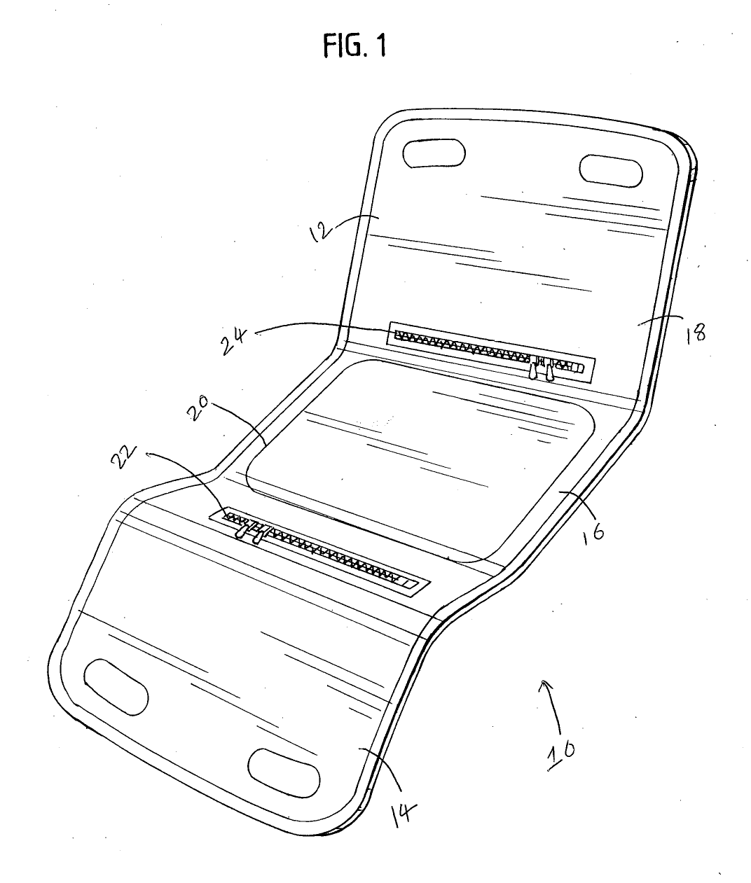

Now referring to the various embodiments illustrated in the attached figures, FIG. 1 illustrates An embodiment of protective cover 10 which is may be made of a flexible panel 12 of an approximately rectangular shape. While in the present embodiment the flexible panel 12 is shown to be of rectangular shape, in an alternate embodiment, the flexible panel 12 may be of an alternate shape, such as, for example, an oval, etc. The material used to make the flexible panel may be cotton, plastic, polyester, nylon, vinyl, etc.

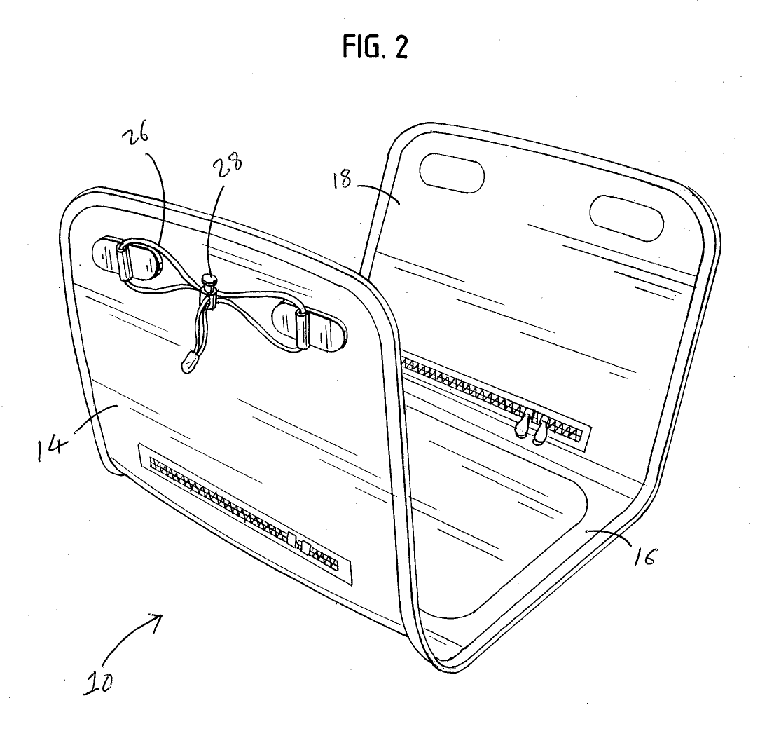

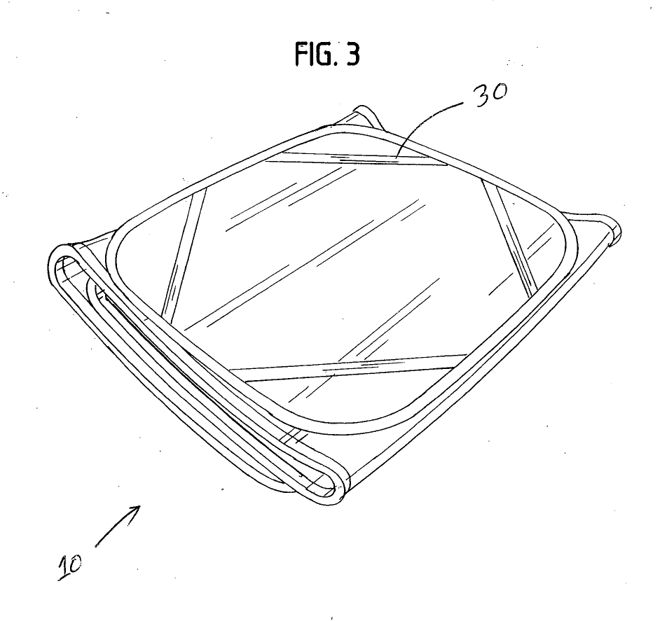

In FIG. 1, the flexible panel 12 is illustrated to be approximately divided into three sections, a front section 14, a middle section 16, and a back section 18. While the illustrated embodiment of the flexible panel 12 includes three sections, in an alternate embodiment, less than three sections may also be provided. Similarly, while the illustrated embodiment of the flexible panel 12 has each of the three sections 14-18 of approximately similar shape, in an alternate embodiment, the shapes and sizes of one or more of the three sections may be different from each other. The front section 14 and the back section 18 may be foldably connected to the middle section 16 in that, they may be folded on top of the middle section 16, as further illustrated in FIGS. 2-4.

The middle section 16 may be supported by a supporting mechanism made of a semi-rigid or rigid material, where such supporting mechanism can be detachably attached to the middle section 16. For example, the middle section 16 may be made of two layers with an opening between the two where a cardboard or other supporting mechanism may be inserted. In an alternate embodiment, the middle section 16 may be provided with a Velcro mechanism to attach the supporting mechanism. However, in an alternate embodiment the middle section 16 may also be simply kept without any supporting mechanism. Moreover, while the illustrated embodiment of the flexible panel 12 has a supporting mechanism only in the middle section 16, in an alternate embodiment each of the three sections 14-18 may be provided with such a supporting mechanism.

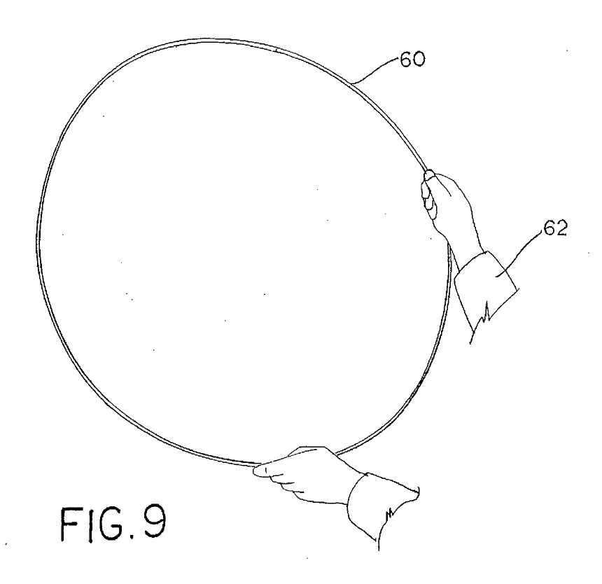

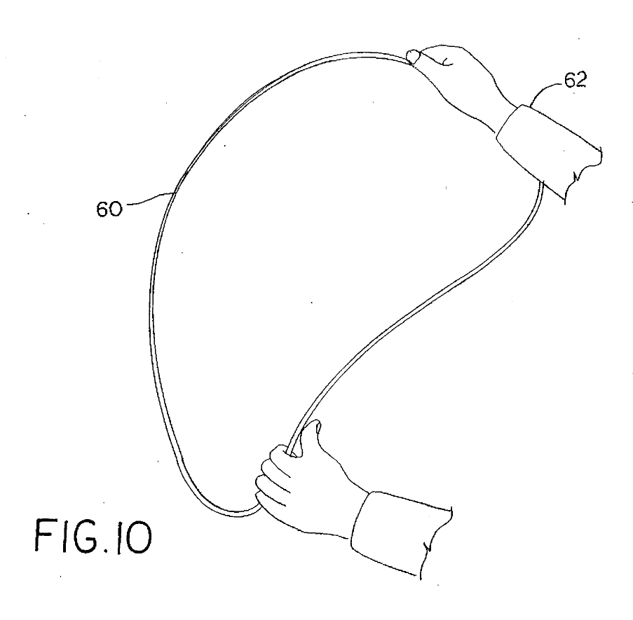

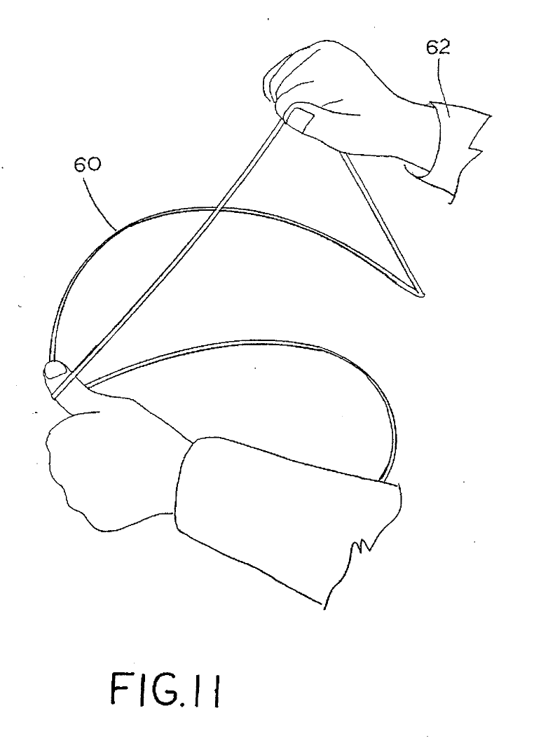

The middle section 16 may be provided with a channel 20 adapted to hold a tensile strip. An example of such a tensile strip is provided below in FIGS. 9-12. In the embodiment of the protective cover illustrated in FIG. 1, the channel 20 may be located in a manner so that it is close to the edges of the middle section 16. Alternatively, the channel 20 may be designed so that it forms the edge of the middle section 16. Similarly, in an alternate embodiment, the channel may also be located in a different position. The tensile strip may be inserted into the channel 20 so that it may be easily removed by a user. Such removable tensile strip allows a user to take the tensile strip out of the flexible panel 12 and to wash the flexible panel in washer or by any other means. Moreover, while the illustrated embodiment of the flexible panel 12 has a tensile strip only in the middle section 16, in an alternate embodiment each of the three sections 14-18 may be provided with a channel to hold such a tensile strip.

The protective cover 10 illustrated in FIG. 1 includes two zippers, each located at the edges of the middle section 16 connecting to the front and the back sections 14 and 18. The zipper 22 is located between the middle section 16 and the front section 14, while the zipper 24 is shown to be located between the middle section 16 and the top section 18. The zippers 22, 24 are designed such that the opening of these zippers may be located at any point along the length of the zippers 22, 24. In an alternate embodiment, the zippers 22, 24 may also be designed in a manner so that each zipper allows there to be two openings. When an embodiment of the protective cover 10 is used in the back seat of a car, the openings in the zipper 24 may allow the car seat belt buckles to pass through such openings. This allows the seat belt to be used to secure, for example, an animal seating on the protective cover 10, etc. The protective cover 10 may be used, for example, for seating a pet in a back seat of a car, for transporting cargo in the trunk of a car, etc. While the embodiment of the flexible panel 12 has zippers on both sides of the middle section 14, in an alternate embodiment, only one of the two zippers 22, 24 may be provided. Yet alternatively, in an alternate embodiment, the flexible panel 12 may be provided without any of the zippers 22, 24.

Now referring to FIG. 2, the protective cover 10 of FIG. 1 is illustrated in here in a partially folded form. The protective cover 10, in such folded form may be placed, for example, in the back seat of a car, in the back of an SUV, etc., to protect the seat or to carry pets, grocery, other cargo, etc. As shown in FIG. 2, the front section 14 is further adapted to have a loop 26 that may be tightened/loosened using a tightening mechanism 28. The loop 26 may be used to secure the protective cover 10 in a position by tying it to another structure. For example, when the protective cover 10 is used on the back seat of a car, the loop 26 may be used to tie the protective cover 10 to a headrest of the front seat. While the illustration in FIG. 2 does not show a loop on the back of the back section 18, in practice such a loop may also be provided to, for example, tie the protective cover 10 to the headrest of the back seat. Similarly, as one of ordinary skill in the art would appreciate, more than one loop structure on each of the front section 14 and the back section 18 may also be provided in an alternate embodiment of the protective cover 10.

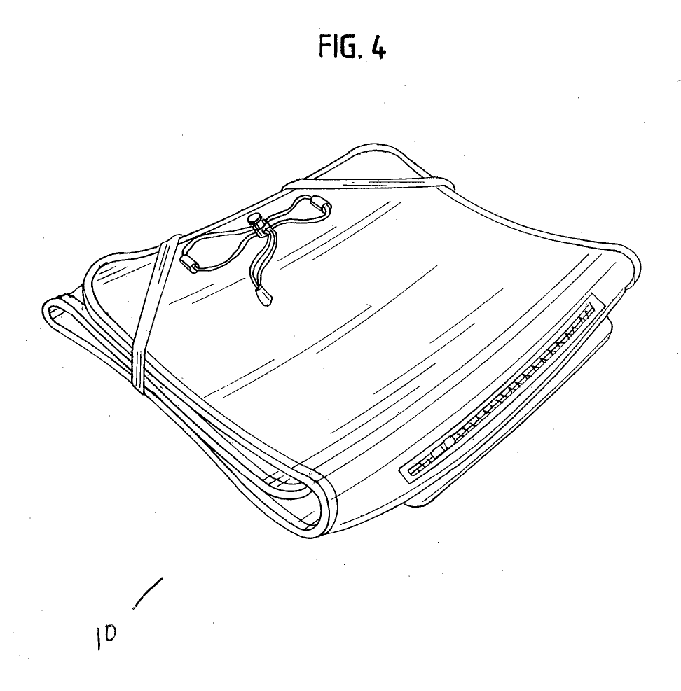

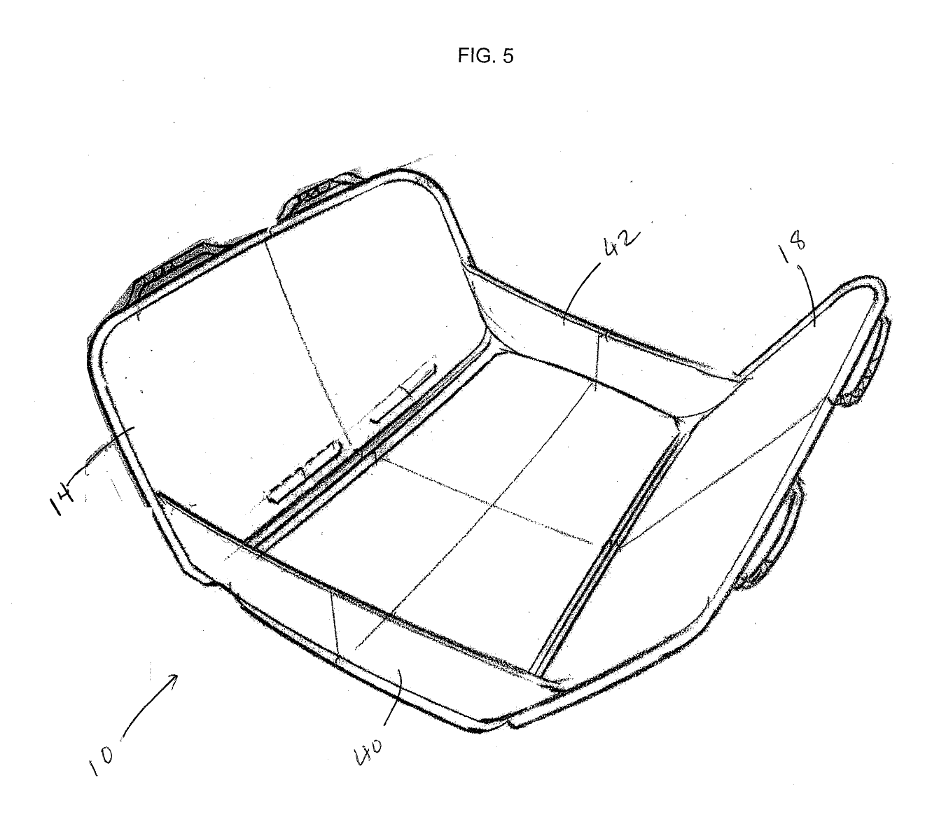

FIG. 3 illustrates an alternate view of the protective cover 10. Specifically, FIG. 3 illustrates a bottom view of the protective cover 10, wherein the front section 14 and the back section 18 are folded on top of the middle section 16. As shown in FIG. 3, the bottom layer of the middle section 16 may be provided with straps 30, made or elastic or other material, that may be used to attach a supporting mechanism to the middle section. Note that while the embodiment illustrated in FIG. 3 has four straps 30, one on each corner, in an alternate embodiment an alternate number of straps or no straps may be provided. FIG. 4 illustrates a top view of the protective cover 10, when it is folded in a matter similar to that of FIG. 3. FIG. 4 illustrates how one or more of the straps 30 may be used to secure the front section 14 and/or the back section 18 together with the middle section 16.

FIG. 4a illustrates an alternate bottom view of the protective cover 10. Specifically, FIG. 4a illustrates a removable tensile strip 34 that may be inserted in between two layers of flexible material forming the middle section 16. The tensile strip 34 is sized in a manner so that due to the tensile nature of the tensile strip 34 it tautly adjusts to the edge of the middle section 16. A user of the protective cover 10 may remove the tensile strip 34 from the middle section 16 and throw the protective cover into a washer, etc. for washing.

FIG. 4b illustrates yet another alternate bottom view of the protective cover 10. Specifically, FIG. 4b illustrates a removable tensile strip 34 that may be inserted into the middle section 16 of the protective cover 10. The flexible tensile strip 36 may be inserted between two layers of the flexible material forming the middle section 16 of the protective cover 10 by opening a zipper 38 provided therein. This arrangement also makes it easy for a user of the protective cover 10 to remove the tensile strip 36 and throw the protective cover into a washer, etc.

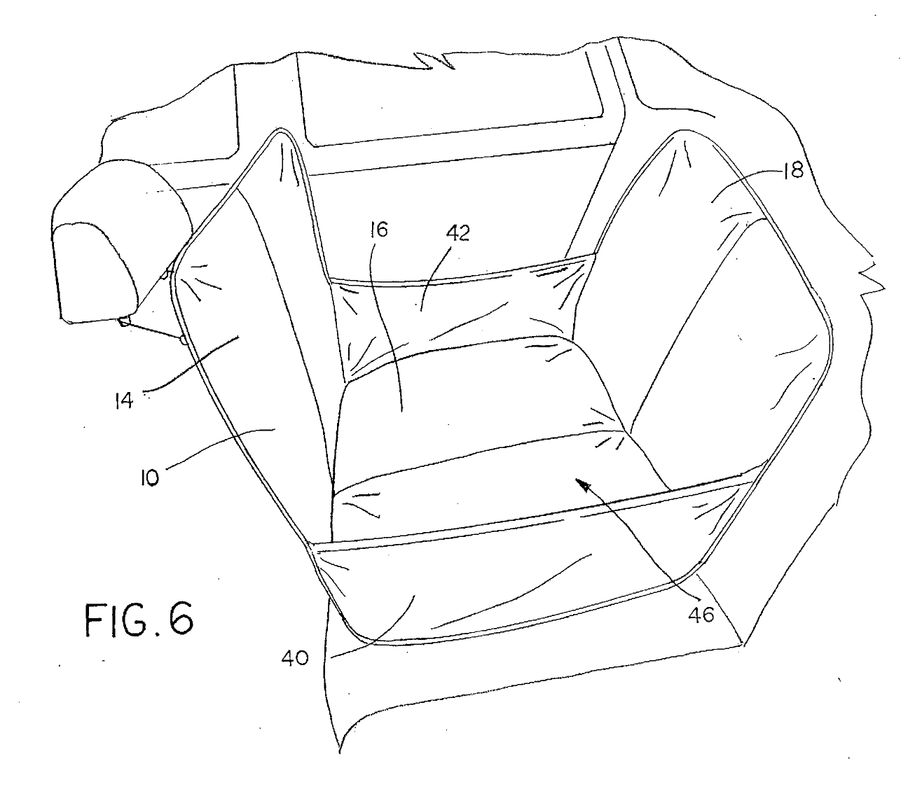

Now referring to FIG. 5, an alternate embodiment of protective cover 10 is shown to have the front section 14 and the back section 18 connected by a left section 40 and a right section 42. Note that the embodiment of FIG. 5 is broader than the earlier embodiments illustrated in FIGS. 1-4 in that each of the various sections of the protective cover are wider. Moreover, each of the front and the back sections 14 and 18 are illustrated to have two loops on their back. Such a protective cover may be used to cover the entire length of the back seat of a car so that each loop connects to a separate headrest. Moreover, as one of ordinary skill in the art would recognize, while the left and the right sections 40-42 are illustrated to be of rectangular shape, in an alternate embodiment, these sides may also be of another shape, such as a triangle, etc. Similarly, while the left and the right sections 40-42 are implemented for a protective cover having three sections, in an alternate embodiment these sections may also be implemented with a protective cover having only two sections such as only the middle section 16 and the back section 18.

The left section 40 and the right section 42 may be made of flexible material such as cloth, plastic, polyvinyl, nylon, polyester, polyvinyl, etc., in a manner so that when the front section 14 and the back section 18 are folded on top of the middle section 16, the left and the right sections 40-42 also fold on top of the middle section 16. When the protective cover 10 as illustrated in FIG. 5 is used in a car back seat or at any other place, it allows to store groceries and other material on top of the protective cover in a manner so that it does not spill on the sides. The protective cover 10 can also be used to lay a pet bed on it so that a pet can sleep on it.

FIG. 6 illustrates such layout of the protective cover 10 illustrated in FIG. 5 on the back seat 44 of a car. Pets, such as dogs or cats, can be placed in the cover so that the backseat of the vehicle is not damaged by the pets or covered with pet hair. Alternatively, the protective cover 10 can be used in various environments, such as, for example the front seat of a vehicle, the cargo portion of a station wagon or sport utility vehicle (“SUV”), or on a ground surface (i.e., in a house, outside, etc.) and still be within the spirit and scope of the invention.

The protective cover 10 includes the middle section 16 (also referred to as the base 16), the back section 18 (also referred to as the rear member 18), the front section 14 (also referred to as the front member 14), and the left section 40 and the right section 42 (also referred to as the side members 40, 42), which together form a cavity 46 for receiving a pet, groceries, etc. The base 16 may be supported on the seat portion of the back seat to protect the seat portion. The back section 18 may be oriented in a generally upright position to protect the backrest portion of the back seat. The front section 14 may be also oriented in a generally upright position to protect the front seats. Alternatively, the front section 14 may also be folded below the middle section 16 to use the protective cover 10 with only two sections. The side members 40, 42 are connected at a bottom thereof to the base 16 and at ends thereof to a respective one of the front section 14 and the back section 16. In some embodiments, the base and the rear, front, and side members may be sewn together. In other embodiments, the base and the rear, front, and side members are integral. Preferably, the protective cover 10 is waterproof in order to contain pet accidents. In some embodiments, the cover is made of a waterproof material. In other embodiments, the cover may have a first internal material for engagement with the pet and a second external waterproof backing material for preventing leaks. Alternatively, a sponge material may be provided in any section of the protective cover 10 for comfort.

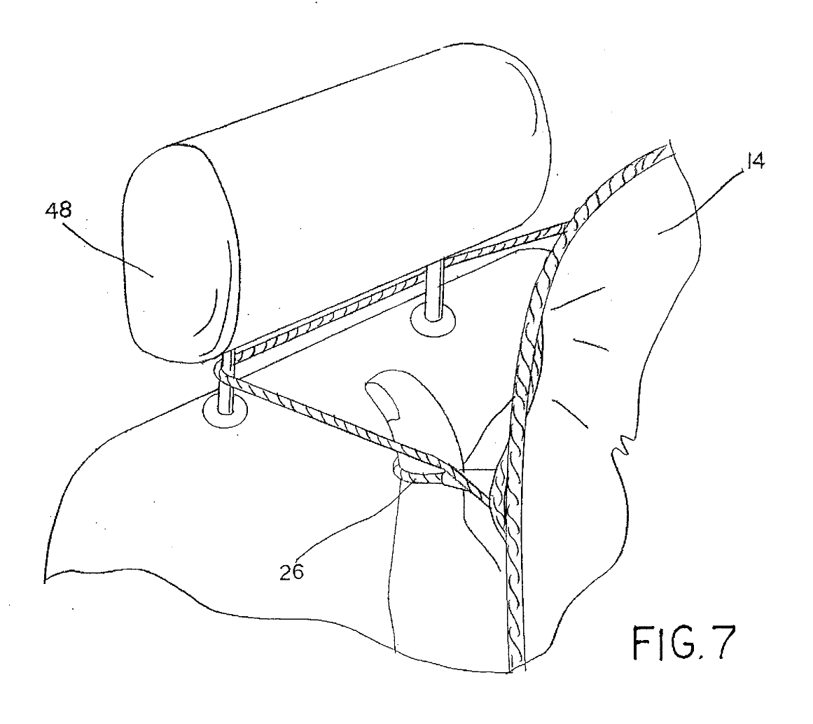

FIG. 7 illustrates the use of the loop 26 connected to the back of the front section 14 and the back section 18. Specifically, FIG. 7 illustrates use of the loop 26 connected to the front section 14 to secure the front section 14, and thereby the protective cover 10, to the headrest 48 of a front seat of a car. Such connection prevents the protective cover 10 and its various sections from collapsing or moving from their proper positions. In the illustrated embodiment, the loop 26 is an elastic cord that can be provided on back of both of the front section 14 and the back section 18. Alternatively, the loop 26 may also be attached to the top or any other portion of the front section 14 and the back section 18. The loop 26 may wrap around the headrest 48 of the seat and secure the protective cover 10 in place. Alternatively, the loop 26 could be straps connectable by hook and loop fasteners, snaps, tying ends together, etc., or any other manner of connecting the rear and front members to the headrests. In some embodiments, the protective cover 10 may be made of a material sufficiently rigid to support itself in a proper orientation within the rear seat of the vehicle without the need for connecting member to secure the rear and front members to the seats.

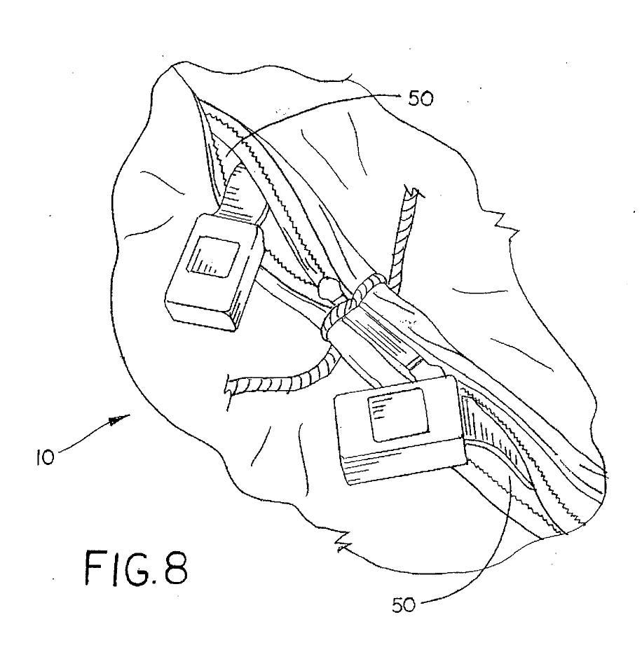

Referring now to FIG. 8, the protective cover 10 is illustrated to include a plurality of seat belt openings 50 to allow buckles of the seat belts to pass through the protective cover 10 and facilitate operation of the seat belts. In the illustrated embodiment, the cover includes a zipper 54 to selectively open and close each of the seat belt openings. Alternatively, the seat belt opening could be selectively opened and closed by other devices, such as, for example a hook and loop fastener, snaps, ties, etc.

As discussed above with respect to FIGS. 1-8, one or more sections of the protective cover 10 may be provided with a tensile strip to give such sections resilient frames and necessary rigidity. Such tensile strips also enable transformation of the protective cover from its open condition to a storage condition (discussed below in greater detail). An exemplary implementation of such tensile strips is illustrated in FIGS. 9-12 below.

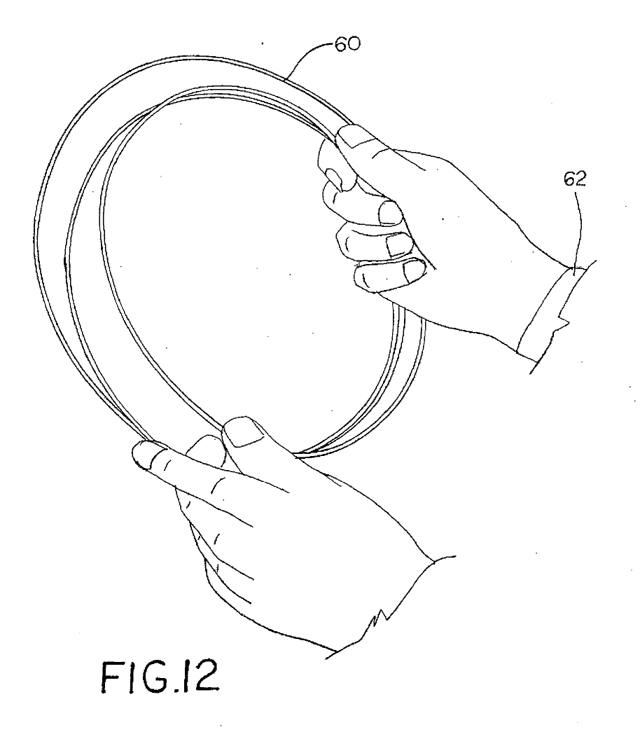

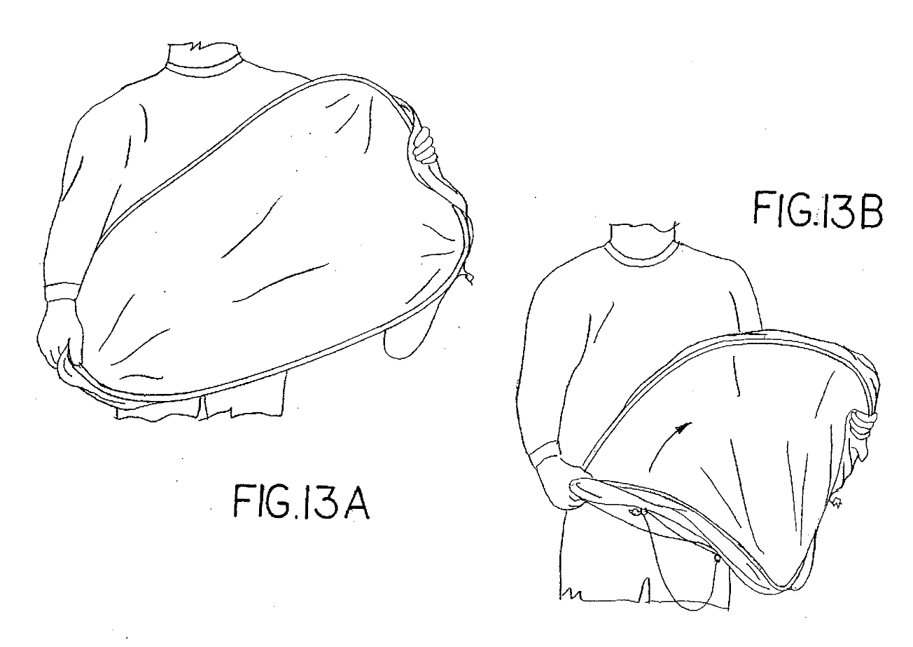

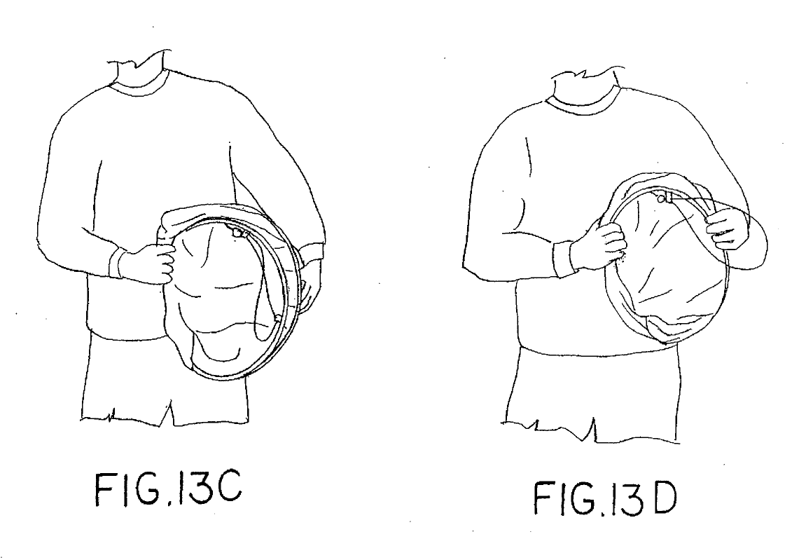

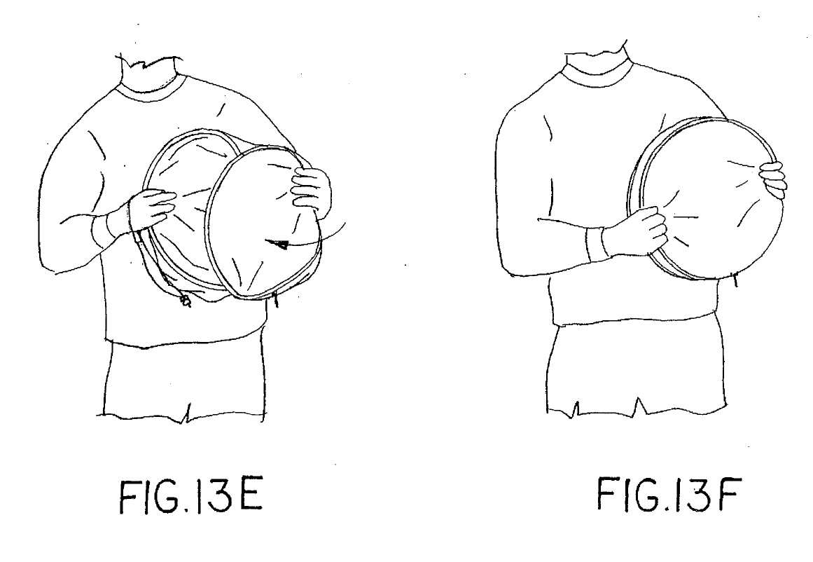

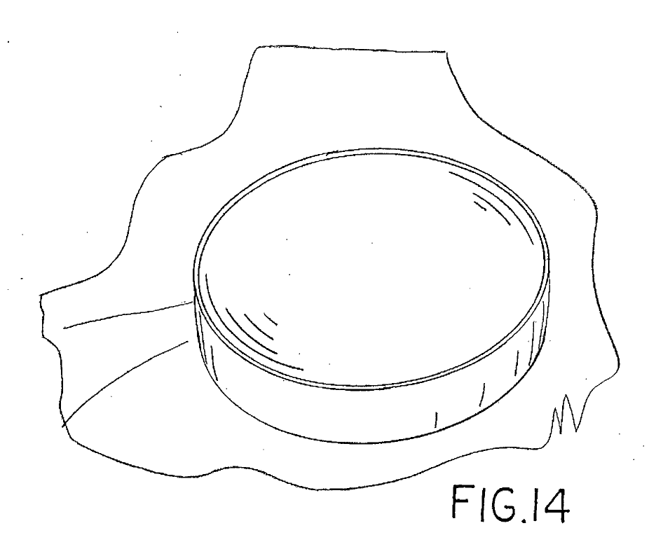

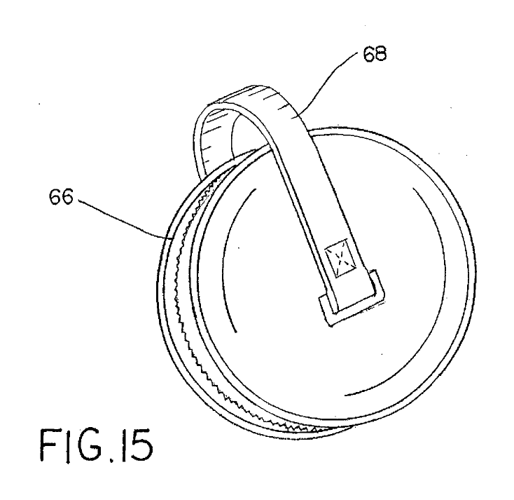

Specifically, FIG. 9 shows such a tensile strip 60 of a circular shape that may be used in the protective cover 10. The tensile strip in this form can be inserted into the channel 20 as shown in FIG. 1 above. However, in an alternate embodiment, the tensile strip 60 may be inserted into each of the front, middle and back sections 14-18. FIGS. 9-12 illustrate how the tensile strip 60, and therefore the protective cover 10 having one or more of such tensile strips, may be folded by a user 62 into a compact package (further disclosed below in FIG. 14). FIG. 10 illustrates the user 62 starting to fold the strip 60 into its compact form and FIG. 11 further illustrates the strip 60 in partially folded form. Finally FIG. 12 illustrates the strip 60 into its final three ring compact form. As one of ordinary skill in the art would appreciate, when the strip 60 inserted into the protective cover 10, each section of the protective cover 10, and therefore the entire protective cover 10, may be folded into a compact and approximately circular form having three layers.

While the tensile strip 60 may be formed in a continuous loop and secured within the channels extending around the periphery of each of the front, middle and back sections 14-18, in an alternate embodiment, only one or two of the front, middle and back sections 14-18 may contain such tensile strip 60. The tensile strip 60, shown in its deformed compact form in FIG. 12, will return to its normal shape as shown in FIG. 9. This feature is particularly helpful in enabling the protective cover 10 to transform between its open condition and storage condition (discussed in more detail below).

Referring to FIGS. 13, the cover is illustrated in various steps as it is transformed from the open condition (FIG. 13a) to the storage condition (FIG. 13f). Transformation of the cover from the open condition to the storage condition will now be described. In FIG. 13a, the cover is illustrated in the open condition. Here the loop 26 of the protective cover is removed from the headrests of the front and rear seats of a car and the front, middle and back sections 14-18 are folded on top of each other. In one alternative folding process the front section 14 is folded downward toward the middle section 16 and the back section 18 is folded downward toward the middle section 16 and into contact with the front section 14. Alternatively, the back section 18 may be folded downward toward the middle section 16 first, followed by the front section 14.

Once the back and the front sections 18, 14 are folded toward the middle section 16, the protective is held as shown in FIG. 13a. In 13b, the protective cover is shown to be further folded in a manner similar to the folding of the tensile strip 60 as shown in FIG. 10. Thus, in FIG. 13b the ends of the protective cover 10 are folded toward each other. As shown in FIGS. 13c-d, due to the tensile strip(s) 60 within various sections of the protective cover 10, the resilient frame begins to deform into a circular shape, thereby deforming the protective cover 10 into a circular shape. FIG. 13e illustrates the folded stage of the protective cover 10 being inserted into a storage case, and finally FIG. 13f shows the compact storage case containing the folded protective cover. Thus, as shown herein, folding of the protective cover 10 will eventually position the protective cover 10 into the storage condition in which the protective cover 10 is substantially circular in shape and much more compact than the protective cover 10 in the open condition. FIG. 14 shows the protective cover 10 in a storage case.

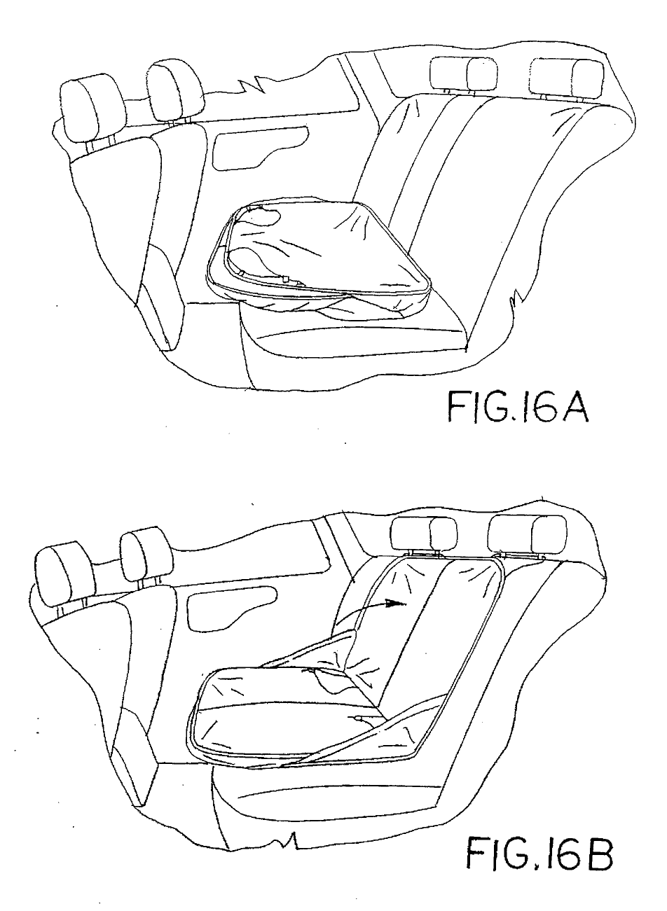

With reference to FIG. 15, the protective cover 10 is illustrated in a storage condition and is disposed within a storage case 66 having an accessory strap 68. The accessory strap can act as a handle for carrying the cover and case, or the strap can act as a hook for hanging the cover and case for storage purposes. The accessory strap can assume a variety of shapes and configurations and still be within the spirit and scope of the present invention.

The protective cover 10 is relatively compact when in the storage condition and stored in the storage case. Accordingly, the protective cover 10 consumes a small amount of space in a vehicle while not in use. Space in vehicles is very valuable due to the limited quantity thereof. The storage case maintains the cover in the storage condition. Alternatively, the protective cover 10 can be maintained in the storage condition by other devices, such as, for example an elastic cord, a strap, ties, etc.

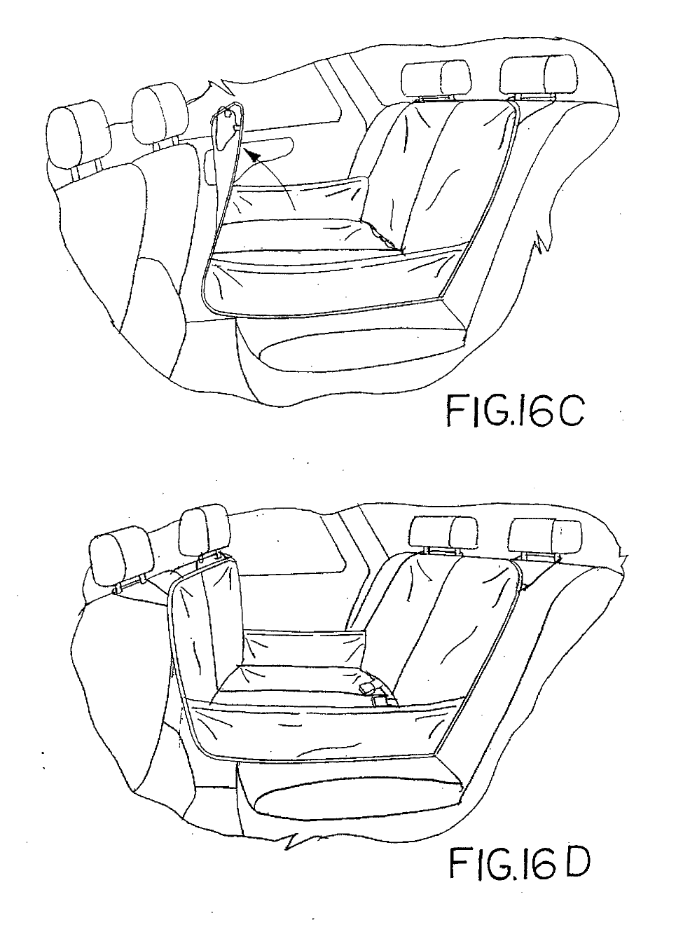

To return the cover to the open condition, the cover only needs to be removed from the storage case and the resilient frame will automatically return to its original shape, thereby returning the cover to the shape illustrated in FIG. 16a. Then the back section 18 is folded up as shown in FIG. 16b and the front section is folded upward as shown in FIG. 16c and secured to the headrests with the loops 26 as shown in FIG. 16d. As can be seen, transforming the protective cover 10 between the open and storage conditions is simple, quick, and intuitive.

It should be understood that the protective cover 10 may be used in a variety of applications other than as a seat protection cover for a pet. For example, the cover can be used as a place for containing dirty shoes (i.e., a shoe mat) and can be place in a vehicle or elsewhere, such as, for example in a house or outside.

Also, it should be understood that the protective cover 10 may be formed in a variety of shapes and sizes to accommodate various environments. For example, the protective cover 10 can be sized and shaped as illustrated to cover approximately three-quarters of a back seat of a standard sized car. Alternatively, the protective cover 10 can be sized and shaped to cover a small portion of the back seat of a car, the entire back seat of a car, the cargo space in the rear of an SUV, a bed of a truck, etc.

Preferred embodiments of this invention are described herein. Variations of those preferred embodiments will become apparent to those of ordinary skill in the art upon reading the foregoing description. Skilled artisans may employ such variations as appropriate, and the invention may be practiced otherwise than as specifically described herein. Accordingly, the illustrated embodiments includes all modifications and equivalents of the described subject matter, and any combination of the above-described elements, together with variations thereof, is encompassed by the invention unless otherwise indicated herein or otherwise clearly contradicted by context.

In view of the many possible embodiments to which the principles of this patent may be applied, it should be recognized that the embodiments described herein with respect to the drawing figures are meant to be illustrative only and should not be taken as limiting the scope of patent. For example, for performance reasons one or more components of the method of the present patent may be implemented in hardware, rather than in software. Therefore, the patent as described herein contemplates all such embodiments as may come within the scope of the following claims and equivalents thereof.

1. A protective cover comprising:
a flexible panel of an approximately rectangular shape, the panel having a right edge and a left edge opposite and parallel to each other, and a top edge and a bottom edge opposite and parallel to each other;
at least one channel located on the flexible panel to hold a tensile strip;
wherein the tensile strip is adapted to be folded into at least three loops connected to each other; and
wherein each of at least two but no more than three sections of the tensile strip are adjacent to one of the right edge, the left edge, the top edge and the bottom edge of the flexible panel.

2. The protective cover of claim 1, wherein each of three sections of the tensile strip are adjacent to one of the right edge, the left edge, the top edge and the bottom edge of the flexible panel.

3. The protective cover of claim 1, wherein the tensile strip is made of at least one of: (1) a metallic spring; and (2) a spring made of plastic material.

4. The protective cover of claim 2, wherein the tensile strip forms a complete loop.

5. The protective cover of claim 4, further comprising a zipper located on the flexible panel the zipper being adjacent to a section of the tensile strip that is not adjacent to any edge of the flexible panel.

6. The protective cover of claim 5, wherein the zipper is adapted to be closed from either end and to provide at least one opening.

7. The protective cover of claim 1, wherein each of only two sections of the tensile strip is adjacent to one of the right edge, the left edge, the top edge and the bottom edge of the flexible panel.

8. The protective cover of claim 1, wherein the channel forms the edge of the flexible panel and the channel is formed by stitching the two layers of flexible panel.

9. The cargo protector of claim 1, wherein the flexible panel is made of two layers of flexible material and wherein the channel is sewed into the flexible panel.

10. The protective cover of claim 1, wherein the flexible panel is further divided into a middle section and a back section with the flexible channel encompassing only the middle section.

11. The protective cover of claim 1, wherein the flexible panel is further divided into a middle section, a front section, and a back section with the flexible channel encompassing at least one of the middle section, the front section, and the back section.

12. The protective cover of claim 11, further comprising a zipper between at least one of: (1) the middle section and the back section, and (2) the middle section and the front section.

13. The protective cover of claim 11, further comprising at least one connecting loop attached to at least one of the front section and the back section, the connecting means adapted to secure the at least one of the front section and the back section.

14. The protective cover of claim 11, further comprising:
a right flexible panel, the right flexible panel attached to the right edge of the middle section, and at least part of the right edges of the front and the back sections; and
a left flexible panel, the left flexible panel attached to the left edge of the middle section, and at least part of the left edges of the front and the back sections.

15. The protective cover of claim 1, further adapted to allow the tensile strip to be removed from the channel.

16. A method of folding a protective cover having a flexible panel into a compact form, the method comprising:
inserting a tensile strip into a channel located on the flexible panel;
folding each of the multiple sections of the flexible panel on top of each other;
twisting the folded flexible panel into three loops in a single plane; and
folding each of the three loops on top of each other.

17. The method of claim 16, further comprising:
unfolding the protective cover from its compact form; and
removing the tensile strip from the channel.

18. A protective cover, comprising:
A middle section located in between and attached to a front section and a top section;
Each of the middle section, the front section and the top section having a channel adapted to receive a tensile strip, wherein the tensile strip is adapted to be folded into three loops connected to each other.

19. The protective cover of claim 18, further comprising a zipper between at least one of: (i) the front and the middle sections; and (ii) the back and the middle sections.

20. The protective cover of claim 18, wherein the middle section further comprises a pocket space to receive a supporting material insert.
